(19) United States
(12) Patent Application Publication
(10) Pub. No.: US 2024/0298256 A1
(43) Pub. Date: Sep. 5, 2024

(54) COMMUNICATION METHOD AND COMMUNICATION APPARATUS

(71) Applicant: HUAWEI TECHNOLOGIES CO., LTD., Shenzhen (CN)

(72) Inventors: Dongdong Wei, Shanghai (CN); Yongxia Lyu, Shenzhen (CN); Ting Wang, Shanghai (CN)

(73) Assignee: HUAWEI TECHNOLOGIES CO., LTD., Shenzhen (CN)

(21) Appl. No.: 18/646,712

(22) Filed: Apr. 25, 2024

Related U.S. Application Data
(63) Continuation of application No. PCT/CN2022/124821, filed on Oct. 12, 2022.

(30) Foreign Application Priority Data
Nov. 9, 2021 (CN) 202111323749.6

(51) Int. Cl. H04W 52/02

(52) U.S. Cl. CPC H04W 52/0206; H04W 52/0216

(57) ABSTRACT

A method includes a terminal device that obtains first power saving information from a first network device, where the first power saving information is related to power saving of the first network device. The terminal device communicates with the first network device based on the first power saving information.

### CROSS-REFERENCE TO RELATED APPLICATIONS

This application is a continuation of International Application No. PCT/CN2022/124821, filed on Oct. 12, 2022, which claims priority to Chinese Patent Application No.202111323749.6, filed on Nov. 9, 2021. The disclosures of the aforementioned applications are hereby incorporated by reference in their entireties.

### TECHNICAL FIELD

Embodiments of the disclosure relate to the communication field, and more specifically, to a communication method and a communication apparatus.

### BACKGROUND

To meet people's increasing demands for traffic, wireless networks are being rapidly constructed. As a network scale expanses, network power consumption increases continuously. For example, in a 5^{th} generation (5G) and 6^{th} generation (6G) mobile communication technology, an active antenna unit (AAU) is put into large-scale commercial use, a quantity of antennas on a base station side increases significantly, and power consumption increases exponentially. For another example, in a 5G and 6G era, a higher data transmission rate and larger traffic are needed, and therefore, more transmission bandwidth is needed, causing an increase in power consumption on the base station side. For still another example, a millimeter wave, terahertz, and the like are used in the communication field. As a result, sites on the base station side are densely deployed, and correspondingly, power consumption is also increased.

The increase in the power consumption not only leads to a significant increase in costs, but also does not meet a regulatory requirement of a government department for power saving and emission reduction. Therefore, how to reduce the power consumption has become an important topic of concerns currently.

### SUMMARY

Embodiments of the disclosure provide a communication method and a communication apparatus. When determining that a first network device can enter a power saving state, the first network device sends first power saving information to a terminal device, so that the first network device can implement shutdown at a smaller granularity in time domain. This helps reduce power consumption of the first network device. In addition, the terminal device obtains shutdown information of the first network device in time domain by obtaining the first power saving information, to avoid invalid data receiving and sending. This helps reduce power consumption of the terminal device.

A first aspect provides a communication method, including: A terminal device obtains first power saving information sent by a first network device, where the first power saving information is information related to power saving of the first network device. The terminal device communicates with the first network device based on the first power saving information.

The first power saving information indicates at least one of the following:
duration of a first power saving cycle;
duration of a first active time period, where specifically, the duration of the first active time period is duration in which the first network device communicates with the terminal device in the duration of the first power saving cycle, and the duration of the first active time period is less than the duration of the first power saving cycle; and
a first time domain offset, where specifically, the first time domain offset is a start time point of the first power saving cycle. Specifically, the first time domain offset may be a start slot/subframe/moment/symbol or the like of the first power saving cycle.

It should be noted that the first power saving information includes one or more of the foregoing items. When the first power saving information does not include the one or more of the foregoing items, an item that is not included is predefined in a protocol or is additionally indicated by another information.

That the terminal device communicates with the first network device based on the first power saving information specifically includes:

The terminal device communicates with the first network device in the duration of the first active time period.

Specifically, that the terminal device communicates with the first network device may be that the terminal device obtains downlink information sent by the first network device, or that the terminal device sends uplink information to the first network device.

According to the method provided in embodiments of the disclosure, when determining that the first network device can enter a power saving state, the first network device sends the first power saving information to the terminal device, where the first power saving information includes the duration of the first power saving cycle, and the duration of the first active time period in the duration of the first power saving cycle. The first network device communicates with the terminal device in some duration (namely, the duration of the first active time period) of duration of each first power saving cycle, and the first network device keeps in a dormant state in some duration, so that the first network device can implement shutdown at a smaller granularity in time domain. This helps reduce power consumption of the first network device. In addition, the terminal device obtains shutdown information of the first network device in time domain by obtaining the first power saving information, to avoid invalid data receiving and sending. This helps reduce power consumption of the terminal device.

With reference to the first aspect, in some implementations of the first aspect, the first power saving information further includes an update condition of the duration of the first active time period.

Specifically, the update condition of the duration of the first active time period may specifically include an extending condition of the duration of the first active time period and a shortening condition of the duration of the first active time period.

It should be understood that the extending condition of the duration of the first active time period is a condition used for determining whether to extend the duration of the first active time period, and the shortening condition of the duration of the first active time period is a condition used for determining whether to shorten the duration of the first active time period.

Specifically, the extending condition of the duration of the first active time period may include at least one of the following:
in last N slots or non-slots of the first active time period, the terminal device detects scheduling information for the terminal device, for example, downlink scheduling information or uplink scheduling information, where N is a positive integer, and it should be understood that the non-slot may also be referred to as a mini-slot;
in the first active time period, in other words, before an end of the first active time period, a data volume scheduled by the terminal device is less than a threshold, where in a specific example, before the end of the first active time period, a data volume scheduled in an UL grant is less than a BSR value reported by the terminal device; and
in the first active time period, in other words, before the end of the first active time period, the terminal device has at least one transport block that is not successfully transmitted, where specifically, the transport block may include one or more data packets.

Specifically, the shortening condition of the duration of the first active time period may include at least one of the following:
in M consecutive slots or non-slots in the first active time period, the terminal device detects no scheduling information for the terminal device, for example, downlink scheduling information or uplink scheduling information, where M is a positive integer, where it should be understood that the non-slot may also be referred to as the mini-slot; and
in M slots or non-slots before an end of the first active time period, a data volume scheduled by the terminal device has reached a threshold.

The terminal device determines, based on the update condition of the duration of the first active time period, whether to update the duration of the first active time period, so that more flexible shutdown of the first network device in time domain and more flexible shutdown of the terminal device in time domain are implemented, and an actual communication requirement can be met.

It should be understood that when the terminal device determines that the update condition of the duration of the first active time period is met, the terminal device determines updated duration of the first active time period.

Optionally, the updated duration of the first active time period may be determined by the terminal device.

Optionally, the updated duration of the first active time period may be predefined in a protocol.

Optionally, the updated duration of the first active time period may be indicated by the first network device to the terminal device.

That the terminal device communicates with the first network device in the duration of the first active time period specifically includes:

The terminal device communicates with the first network device in the updated duration of the first active time period.

With reference to the first aspect, in some implementations of the first aspect, the terminal device obtains first indication information sent by the first network device in a multicast manner, where the first indication information is scrambled by using a predefined radio network temporary identifier RNTI, and the RNTI indicates to update the duration of the first active time period. The terminal device determines updated duration of the first active time period based on the first indication information.

That the terminal device communicates with the first network device in the duration of the first active time period specifically includes:

The terminal device communicates with the first network device in the updated duration of the first active time period.

When determining that the duration of the first active time period needs to be updated, the first network device indicates, to the terminal device via the first indication information, that the duration of the first active time period needs to be updated, and the first network device directly sends the first indication information to the terminal device to indicate the terminal device to update the duration of the first active time period, so that the first network device controls the terminal device more precisely. This helps synchronize end-to-end power saving information, and reduces power consumption of the first network device and the terminal device.

With reference to the first aspect, in some implementations of the first aspect, the terminal device obtains configuration information sent by the first network device, where the configuration information includes second power saving information, and the second power saving information is information related to power saving of a second network device. The terminal device measures, based on the configuration information, a cell corresponding to the second network device.

The configuration information includes related power saving information corresponding to a to-be-measured cell, so that the terminal device measures the to-be-measured cell when the to-be-measured cell is in an active time period. This prevents the terminal device from performing unnecessary measurement, and reduces power consumption of the terminal device.

With reference to the first aspect, in some implementations of the first aspect, the terminal device receives second indication information sent by the first network device, where the second indication information indicates whether the first network device receives the uplink information in duration of a first dormant time period.

It should be understood that the duration of the first dormant time period is obtained based on the duration of the first power saving cycle and the duration of the first active time period, or the duration of the first dormant time period is obtained based on the duration of the first power saving cycle and the updated duration of the first active time period.

Specifically, the duration of the first dormant time period is obtained by subtracting the duration of the first active time period from the duration of the first power saving cycle, or the duration of the first dormant time period is obtained by subtracting the updated duration of the first active time period from the duration of the first power saving cycle.

It should be noted that the first power saving information and the second indication information may be sent via a system information.

The first power saving information and the second indication information are sent via the system information, so that a group of terminal devices may all be notified. This reduces system overheads.

A second aspect provides a communication method, including: A first network device sends first power saving information to a terminal device, where the first power saving information is information related to power saving of the first network device. The first network device communicates with the terminal device based on the first power saving information.

The first power saving information indicates at least one of the following:
duration of a first power saving cycle;
duration of a first active time period, where specifically, the duration of the first active time period is duration in which the first network device communicates with the terminal device in the duration of the first power saving cycle, and the duration of the first active time period is less than the duration of the first power saving cycle; and
a first time domain offset, where specifically, the first time domain offset is a start time point of the first power saving cycle. Specifically, the first time domain offset may be a start slot/subframe/moment/symbol or the like of the first power saving cycle.

It should be noted that the first power saving information includes one or more of the

foregoing items. When the first power saving information does not include the one or more of the foregoing items, an item that is not included is predefined in a protocol or is additionally indicated by another information.

That the first network device communicates with the terminal device based on the first power saving information specifically includes:

The first network device communicates with the terminal device in the duration of the first active time period.

According to the method provided in embodiments of the disclosure, when determining that the first network device can enter a power saving state, the first network device sends the first power saving information to the terminal device, where the first power saving information includes the duration of the first power saving cycle, and the duration of the first active time period in the duration of the first power saving cycle. The first network device communicates with the terminal device in some duration (namely, the duration of the first active time period) of duration of each first power saving cycle, and the first network device keeps in a dormant state in some duration, so that the first network device can implement shutdown at a smaller granularity in time domain. This helps reduce power consumption of the first network device. In addition, the terminal device obtains shutdown information of the first network device in time domain by obtaining the first power saving information, to avoid invalid data receiving and sending. This helps reduce power consumption of the terminal device.

With reference to the second aspect, in some implementations of the second aspect, the first power saving information further includes an update condition of the duration of the first active time period.

Specifically, the update condition of the duration of the first active time period may specifically include an extending condition of the duration of the first active time period and a shortening condition of the duration of the first active time period.

It should be understood that the extending condition of the duration of the first active time period is a condition used for determining whether to extend the duration of the first active time period, and the shortening condition of the duration of the first active time period is a condition used for determining whether to shorten the duration of the first active time period.

Specifically, the extending condition of the duration of the first active time period may include at least one of the following:
in N slots or non-slots before an end of the duration of the first active time period, the terminal device detects scheduling information for the terminal device, for example, downlink scheduling information or uplink scheduling information, where N is a positive integer, where it should be understood that the non-slot may also be referred to as a mini-slot;
before the end of the duration of the first active time period, a data volume scheduled by the terminal device is less than a threshold, where in a specific example, before the end of the first active time period, a data volume scheduled in an UL grant is less than a BSR value reported by the terminal device; and
before the end of the duration of the first active time period, the terminal device has at least one transport block that is not successfully transmitted, where specifically, the transport block may include one or more data packets.

Specifically, the shortening condition of the duration of the first active time period may include at least one of the following:
in M consecutive slots or non-slots in the duration of the first active time period, the terminal device detects no scheduling information for the terminal device, for example, downlink scheduling information or uplink scheduling information, where M is a positive integer, and it should be understood that the non-slot may also be referred to as a mini-slot; and
in M slots or non-slots before an end of the duration of the first active time period, a data volume scheduled by the terminal device has reached a threshold. It should be understood that the non-slot may also be referred to as the mini-slot.

The first network device determines, by sensing the terminal device, whether to update the duration of the first active time period, so that more flexible shutdown of the first network device in time domain and more flexible shutdown of the terminal device in time domain are implemented, and an actual communication requirement can be met.

It should be understood that when the first network device determines that the update condition of the duration of the first active time period is met, the first network device determines updated duration of the first active time period.

Optionally, the updated duration of the first active time period may be determined by the terminal device and sensed by the first network device.

Optionally, the updated duration of the first active time period may be predefined in a protocol.

Optionally, the updated duration of the first active time period may be determined by the first network device and indicated to the terminal device.

That the first network device communicates with the terminal device in the duration of the first active time period specifically includes:

The first network device communicates with the terminal device in the updated duration of the first active time period.

With reference to the second aspect, in some implementations of the second aspect, the first network device sends first indication information to the terminal device in a multicast manner, where the first indication information is scrambled by using a predefined radio network temporary identifier RNTI, and the RNTI indicates to update the duration of the first active time period.

That the first network device communicates with the terminal device in the duration of the first active time period specifically includes:

The first network device communicates with the terminal device in the updated duration of the first active time period.

When determining that the duration of the first active time period needs to be updated, the first network device indicates, to the terminal device via the first indication information, that the duration of the first active time period needs to be updated, and the first network device directly sends the first indication information to the terminal device to indicate the terminal device to update the duration of the first active time period, so that the first network device controls the terminal device more precisely. This helps synchronize end-to-end power saving information, and reduces power consumption of the first network device and the terminal device.

With reference to the second aspect, in some implementations of the second aspect, the first network device obtains second power saving information sent by a second network device, where the second power saving information is information related to power saving of the second network device. The first network device sends configuration information to the terminal device, where the configuration information includes the second power saving information, and the configuration information is used by the terminal device to measure a cell corresponding to the second network device.

The configuration information includes related power saving information corresponding to a to-be-measured cell, so that the terminal device measures the to-be-measured cell when the to-be-measured cell is in an active time period. This prevents the terminal device from performing unnecessary measurement, and reduces power consumption of the terminal device.

With reference to the second aspect, in some implementations of the second aspect, the first network device sends second indication information to the terminal device, where the second indication information indicates, to the terminal device, whether the first network device receives uplink information in duration of a first dormant time period.

It should be understood that the duration of the first dormant time period is obtained based on the duration of the first power saving cycle and the duration of the first active time period, or the duration of the first dormant time period is obtained based on the duration of the first power saving cycle and the updated duration of the first active time period.

Specifically, the duration of the first dormant time period is obtained by subtracting the duration of the first active time period from the duration of the first power saving cycle, or the duration of the first dormant time period is obtained by subtracting the updated duration of the first active time period from the duration of the first power saving cycle.

It should be noted that the first power saving information and the second indication information may be sent via a system information.

The first power saving information and the second indication information are sent via the system information, so that a group of terminal devices may all be notified. This reduces system overheads.

A third aspect provides a communication apparatus, including units configured to perform the steps of the communication method in the first aspect and the implementations of the first aspect.

In a design, the communication apparatus is a communication chip, and the communication chip may include an input circuit or an interface configured to send information or data, and an output circuit or an interface configured to receive information or data.

In another design, the communication apparatus is a communication device (for example, a terminal device). A communication chip may include a transmitter configured to send information, and a receiver configured to receive information or data.

A fourth aspect provides a communication apparatus, including units configured to perform the steps of the communication method in the second aspect and the implementations of the second aspect.

In a design, the communication apparatus is a communication chip, and the communication chip may include an input circuit or an interface configured to send information or data, and an output circuit or an interface configured to receive information or data.

In another design, the communication apparatus is a communication device (for example, a first network device). A communication chip may include a transmitter configured to send information, and a receiver configured to receive information or data.

A fifth aspect provides a communication device, including a processor and a memory. The memory is configured to store a computer program. The processor is configured to invoke the computer program from the memory and run the computer program, to enable the communication device to perform the communication method in the first aspect and the implementations of the first aspect.

Optionally, there are one or more processors, and there are one or more memories.

Optionally, the memory may be integrated with the processor, or the memory and the processor are separately disposed.

Optionally, the communication device further includes a transmitter and a receiver. A sixth aspect provides a communication device, including a processor and a memory.

The memory is configured to store a computer program. The processor is configured to invoke the computer program from the memory and run the computer program, to enable the communication device to perform the communication method in the second aspect and the implementations of the second aspect.

Optionally, there are one or more processors, and there are one or more memories.

Optionally, the memory may be integrated with the processor, or the memory and the processor are separately disposed.

Optionally, the communication device further includes a transmitter and a receiver.

A seventh aspect provides a computer program product. The computer program product includes a computer program (which may also be referred to as code or instructions). When the computer program is run, a computer is enabled to perform the communication method according to any one of the first aspect and the second aspect or the implementations of the first aspect and the second aspect.

An eighth aspect provides a communication system. The system includes at least one apparatus configured to perform the method in the first aspect and the implementations of the first aspect.

Optionally, the communication system further includes at least one apparatus configured to perform the method in the second aspect and the implementations of the second aspect.

A ninth aspect provides a communication system. The system includes at least one apparatus configured to perform the method in the second aspect and the implementations of the second aspect.

Optionally, the communication system further includes at least one apparatus configured to perform the method in the first aspect and the implementations of the first aspect.

A tenth aspect provides a chip system. The chip system includes a memory and a processor. The memory is configured to store a computer program. The processor is configured to invoke the computer program from the memory and run the computer program, to enable a communication device on which the chip system is installed performs the communication method in any aspect and the implementations of any aspect.

The chip system may include an input circuit or an interface configured to send information or data, and an output circuit or an interface configured to receive information or data.

### BRIEF DESCRIPTION OF DRAWINGS

FIG. 1 is a schematic diagram of an example of a system architecture to which an embodiment of the disclosure is applied;

FIG. 2 is a schematic diagram of another example of a system architecture to which an embodiment of the disclosure is applied the disclosure;

FIG. 3 is a schematic diagram of an example of a communication method according to an embodiment of the disclosure;

FIG. 4 is a schematic diagram of an example of a first power saving cycle of a first network device according to an embodiment of the disclosure;

FIG. 5 is a schematic flowchart of exchanging power saving information between network devices according to an embodiment of the disclosure;

FIG. 6 is a schematic diagram of another example of a communication method according to an embodiment of the disclosure;

FIG. 7 is a schematic diagram of another example of a communication method

according to an embodiment of the disclosure;

FIG. 8 is a schematic diagram of another example of a communication method according to an embodiment of the disclosure;

FIG. 9 is a schematic diagram of another example of a communication method according to an embodiment of the disclosure;

FIG. 10 is a schematic diagram of an example of a communication apparatus according to an embodiment of the disclosure;

FIG. 11 is a schematic diagram of another example of a communication apparatus according to an embodiment of the disclosure; and

FIG. 12 is a schematic diagram of still another example of a communication apparatus according to an embodiment of the disclosure.

### DESCRIPTION OF EMBODIMENTS

The following describes technical solutions of embodiments in the disclosure with reference to accompanying drawings.

The technical solutions of embodiments of the disclosure may be applied to various communication systems, such as a global system for mobile communication (GSM) system, a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5^{th} generation (5G) system, a 6^{th} generation (6G) system, a new radio (NR) system, or a future next generation wireless communication system, and an non-terrestrial network system, including a satellite communication system and a high altitude platform station (HAPS) communication system, for example, an integrated communication and navigation (ICAN) system, a global navigation satellite system (GNSS), and an ultra-dense low Earth orbit satellite communication system. The satellite communication system may be integrated with a traditional mobile communication system.

A terminal device in embodiments of the disclosure may be user equipment, an access terminal, a subscriber unit, a subscriber station, a mobile station, a mobile console, a remote station, a remote terminal, a mobile device, a user terminal, a terminal, a wireless communication device, a user agent, or a user apparatus. The terminal device may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a 5G network, or a terminal device in a future evolved public land mobile network (PLMN). This is not limited in embodiments of the disclosure.

A network device in embodiments of the disclosure may be a device used to communicate with the terminal device. The network device may be a base transceiver station (BTS) in a global system for mobile communication (GSM) or a code division multiple access (CDMA) system, or may be a NodeB (NB) in a wideband code division multiple access (WCDMA) system, or may be an evolved nodeB (eNB or eNodeB) in an LTE system, or may be a radio controller in a cloud radio access network (CRAN) scenario. Alternatively, the network device may be a relay station, an access point, a vehicle-mounted device, a wearable device, a network device in a 5G network, a network device in an evolved PLMN network, a network device in a future 6G network, or the like. This is not limited in embodiments of the disclosure.

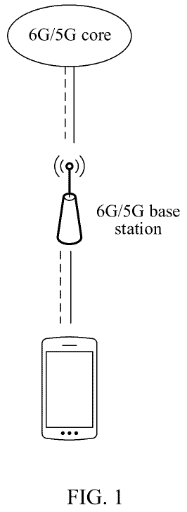

FIG. 1 is a schematic diagram of an example of a system the disclosure architecture to which an embodiment of the disclosure is applied.

As shown in FIG. 1, an disclosure scenario of embodiments of the disclosure may be an SA scenario. A terminal device may be connected to a single base station. The base station connected to the terminal device and a core network connected to the base station are of a same standard. For example, if the core network is a 5G Core, the corresponding base station is a 5G base station, and the 5G base station is connected to the 5G Core. For another example, if the core network is a 6G Core, the corresponding base station is a 6G base station, and the 6G base station is connected to the 6G Core. It should be noted that there may be one or more terminal devices.

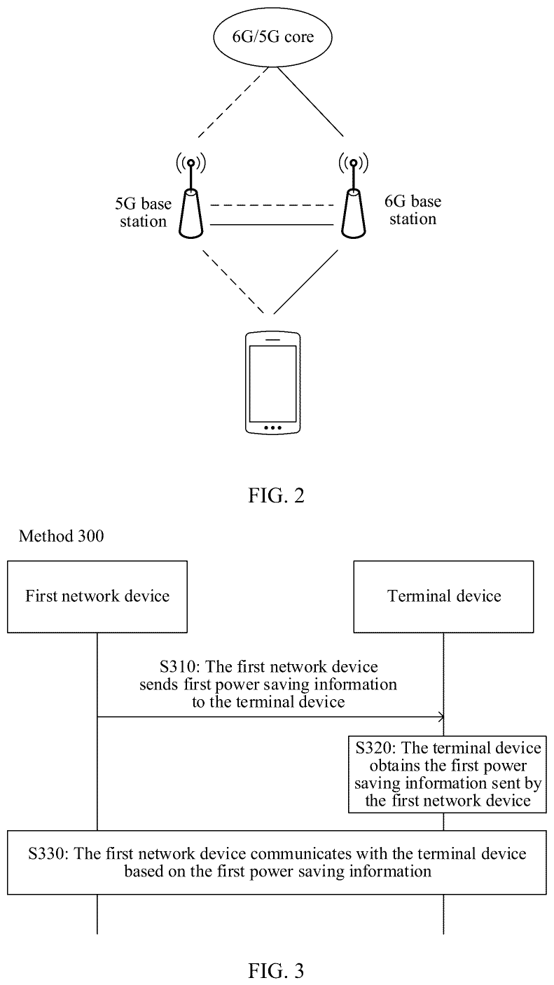

FIG. 2 is a schematic diagram of another example of a system the disclosure architecture to which an embodiment of the disclosure is applied.

As shown in FIG. 2, an disclosure scenario of embodiments of the disclosure may be a DC scenario, and a terminal device may be connected to base stations of different standards or a same standard. For example, a core network is a 5G Core, and the terminal device may be connected to a 5G base station and a 6G base station, where the 5G base station is used as a primary station, and the 6G base station is used as a secondary station. For another example, the core network is a 6G Core, and the terminal device may be connected to the 5G base station and the 6G base station, where the 6G base station is used as a primary station, and the 5G base station is used as a secondary station. For still another example, the core network may be a 6G Core, the terminal device may be connected to two 6G base stations, where both a primary station and a secondary station are the 6G base stations. It should be noted that there may be one or more terminal devices.

FIG. 3 is a schematic diagram of an example of a communication method according to an embodiment of the disclosure. As shown in FIG. 3, the method 300 includes the following steps.

S310: A first network device sends first power saving information to a terminal device.

Specifically, the first power saving information is information related to power saving of the first network device. Alternatively, the first power saving information is related information that is after the first network device enters a power saving state.

It should be noted that there may be one or more terminal devices.

It should be noted that before sending the first power saving information to the terminal device, the first network device determines, according to a system requirement, whether the first network device can enter the power saving state. Specifically, the first network device may determine, based on one or more of information such as a quantity of online terminal devices, a service volume or a data volume of the terminal device, or a quality of service (QOS) requirement of the terminal device, whether the first network device can enter the power saving state.

For example, when the quantity of online terminal devices is small or the quantity of online terminal devices is less than a preset threshold, the first network device determines that the first network device can enter the power saving state. For another example, when the service volume or the data volume of the terminal device is small, or the service volume or the data volume of the terminal device is less than a preset threshold, the first network device determines that the first network device can enter the power saving state. For still another example, when the QoS requirement of the terminal device is low or the QoS requirement of the terminal device is lower than a threshold, the first network device determines that the first network device can enter the power saving state.

Optionally, the first network device may further determine, based on one or more of information such as a quantity of online terminal devices, a service volume or a data volume of the terminal device, and a QoS requirement of the terminal device in a first time period, whether the first network device can enter the power saving state. Optionally, the first time period is predefined in a protocol. The first time period is set, so that the first network device can determine, based on system performance in a time period, whether to enter the power saving state. This avoids system breakdown caused by incorrectly entering the power saving state. In addition, this reduces system power consumption and improves system stability.

It should be understood that the power saving state may also be referred to as a time domain mode, a shutdown state, or a shutdown mode. A specific name of the power saving state is not limited in embodiments of the disclosure. Specifically, in the power saving state, the first network device may perform shutdown in time domain. To be specific, in a time period of one cycle, the first network device sends downlink information, in other words, enters an active time period; and in a remaining time period of the cycle, the first network device does not send the downlink information, in other words, enters a dormant time period.

It should be noted that, in one cycle, duration of the active time period and duration of the dormant time period are both nonnegative integers. The cycle is a first power saving cycle to be described below. It should be understood that the power saving cycle may also be referred to as a shutdown cycle or the like. The name is not particularly limited in embodiments of the disclosure.

Specifically, the first power saving information indicates at least one of the following: duration of the first power saving cycle, duration of a first active time period, and a first time domain offset.

It should be noted that the first network device may send the first power saving information to the terminal device via a system information. Specifically, the first network device may send the first power saving information to the terminal device in a broadcast form via a system information block 1 (SIB1). Optionally, when the first power saving information includes a plurality of the foregoing items, the first network device may send, via the SIB1, content included in the first power saving information to the terminal device in a form of a plurality of broadcast messages, or the first network device may send, via the SIB1, content included in the first power saving information to the terminal device in a form of one broadcast message.

It should be noted that after entering the power saving state, the first network device notifies the terminal device of the power saving information of the first network device, and the terminal device performs adaptive adjustment based on the power saving information of the first network device, and cooperates with the first network device to perform communication. This reduces power consumption of an entire system.

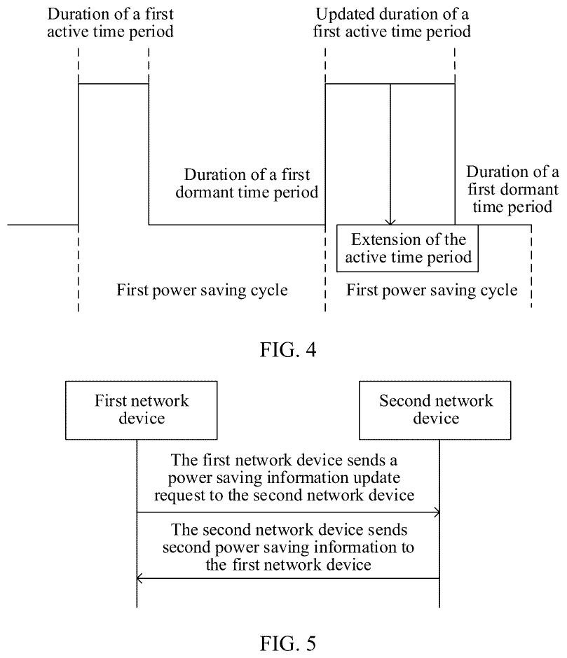

Specifically, FIG. 4 is a schematic diagram of an example of a first power saving cycle of a first network device. As shown in FIG. 4, the first network device performs periodic adjustment in a unit of the first power saving cycle. To be specific, duration of one first power saving cycle includes duration of at least one first active time period (a case in which one power saving cycle includes one active time period is shown in FIG. 4), and a remaining time period is duration of a first dormant time period of the first network device. It should be understood that the active time period and the dormant time period are an active time period and a dormant time period of the first network device.

It should be understood that one first power saving cycle may include more than one active time period. To be specific, the active time period and the dormant time period alternately appear, and there is more than one active time period. For example, in the first power saving cycle, the active time period and the dormant time period alternately appear in a time sequence, for example, an active time period 1, a dormant time period 1, an active time period 2, a dormant time period 2, . . . . This is not limited in embodiments of the disclosure.

It should be understood that the first active time period may start from a start time point of one power saving cycle, or may start from an intermediate time point of one power saving cycle.

Optionally, the first network device may indicate a start location of the first active time period of the terminal device in the first power saving cycle. For example, the first network device may indicate a start moment of the first active time period of the terminal device in the first power saving cycle, or a start subframe of the first active time period in the first power saving cycle, or a start slot of the first active time period in the first power saving cycle, or a start symbol of the first active time period in the first power saving cycle.

Optionally, the first network device may set by default a start location of the first active time period in the first power saving cycle. For example, the first network device sets by default that the first active time period starts from a start moment of one first power saving cycle. For another example, the first network device sets by default that the first active time period starts from an intermediate moment of one first power saving cycle. For still another example, the first network device sets by default that the first active time period ends at an end moment of one first power saving cycle, in other words, a moment that is before the end moment of the power saving cycle and whose distance to the end moment is the duration of the first active time period is the start moment of the first active time period.

Optionally, the first network device may directly indicate a specific value of the duration of the first active time period.

Optionally, a plurality of values of the duration of the first active time period may be predefined in a protocol, and the first network device may indicate one of the values.

For example, a protocol predefines four values of the duration of the active time period: A, B, C, and D, and the first network device may use two bits to indicate one of the values. For example, if a value of a bit sent by the first network device to the terminal device is 00, this indicates that the duration of the first active time period is A; if a value of a bit sent by the first network device to the terminal device is 01, this indicates that the duration of the first active time period is B; if a value of a bit sent by the first network device to the terminal device is 10, this indicates that the duration of the first active time period is C; or if a value of a bit sent by the first network device to the terminal device is 11, this indicates that the duration of the first active time period is D.

Specifically, the first network device communicates with the terminal device in the duration of the first active time period of the first network device. Specifically, the first network device sends downlink information to the terminal device in the duration of the first active time period, and/or the first network device receives, in the duration of the first active time period, uplink information sent by the terminal device. It should be noted that the first network device does not send the downlink information in the duration of the first dormant time period. Correspondingly, the terminal device receives the downlink information in the duration of the first active time period of the first network device, and/or the terminal device sends the uplink information to the first network device in the duration of the first active time period of the first network device. It should be noted that the terminal device does not receive the downlink information in the duration of the first dormant time period of the first network device.

Specifically, the first time domain offset is a start position of the 1^{st} first power saving cycle after the first network device enters the power saving state, for example, a start moment of the 1^{st} first power saving cycle, a start subframe of the 1^{st} first power saving cycle, a start slot of the 1^{st} first power saving cycle, or a start symbol of the 1^{st} first power saving cycle.

It should be noted that when the first network device sends the first time domain offset to the terminal device, the first time domain offset and the duration of the first power saving cycle may be sent in a same message, or may be sent as a separate message.

It should be noted that the first network device may not send the first time domain offset to the terminal device. Optionally, the first time domain offset may be, by default, a moment/slot/subframe/symbol or the like when the first network device sends the first power saving information. Optionally, the first time domain offset may be, by default, the nth moment/slot/subframe/symbol or the like after the first network device sends the first power saving information. Optionally, the first time domain offset may be, by default, a slot, a subframe, or a symbol that is numbered 0 in a radio frame whose frame number is 0.

It should be noted that the first power saving information may include one or more of the duration of the first power saving cycle, the duration of the first active time period, and the first time domain offset, and content that is not included in the first power saving information may be predefined in a protocol or set by default.

Optionally, when the first network device determines that the duration of the first active time period needs to be updated, the first network device may send first indication information to the terminal device in a multicast manner. It should be noted that the first indication information may be scrambled by using a predefined radio network temporary identifier (RNTI). This indicates to update the duration of the first active time period. In other words, the first indication information scrambled by using the predefined RNTI may indicate the terminal device to update the duration of the first active time period.

Optionally, the RNTI may be set to a PS-RNTI. The PS-RNTI is only a set name, or may have another name. This is not limited in embodiments of the disclosure.

FIG. 4 shows a case in which an update of the duration of the first active time period is to extend the duration of the first active time period, or may be a case in which an update of the duration of the first active time period is to shorten the duration of the first active time period. This is not limited in embodiments of the disclosure.

Optionally, a value of the first indication information may directly indicate a specific update value of the duration of the first active time period of the terminal device.

Optionally, the protocol predefines a group of updated values of the duration of the first active time period, or the first network device sends a group of updated values of the duration of first active time period to the terminal device, where the first indication information indicates one of the updated values. Optionally, the first network device broadcasts the group of updated values of the duration of the first active time period to the terminal device via the SIB1.

For example, the protocol predefines or the first network device sends four updated values (a, b, c, and d) of the duration of the first active time period to the terminal device, and the first network device may use two bits to indicate one of the four values. If a value of a bit sent by the first network device to the terminal device is 00, this indicates that the updated value of the duration of the first active time period is a. If a value of a bit sent by the first network device to the terminal device is 01, this indicates that the updated value of the duration of the first active time period is b. If a value of a bit sent by the first network device to the terminal device is 10, this indicates that the updated value of the duration of the first active time period is c. If a value of a bit sent by the first network device to the terminal device is 11, this indicates that the updated value of the duration of the first active time period is d.

Optionally, the protocol predefines the updated value of the duration of the first active time period. The first indication information only indicates to update the duration of the first active time period, and the first network device and the terminal device consider by default that the updated value of the duration of the first active time period is the value predefined in the protocol.

In some embodiments, the first indication information is sent via a media access control control element (MAC CE). Specifically, the protocol predefines MAC CE information for updating the duration of the first active time period. Optionally, the MAC CE information may be sent in a multicast manner.

In some embodiments, the first indication information is sent in a manner of group common downlink control information (group common DCI). Specifically, the protocol predefines DCI format information for updating the duration of the first active time period. It should be noted that the DCI format information carries updated information of first active time periods of one or more cells.

It should be noted that one network device or one base station corresponds to one or more cells. In some cases, the network device in the disclosure and a cell corresponding to the network device may be equivalently replaced.

Specifically, cyclic redundancy check (CRC) scrambling may be performed on the DCI by using a dedicated radio network temporary identifier (RNTI). By way of example but not limitation, an RNTI may be shown in Table 1 below, where a value of the RNTI may be predefined in the protocol. Optionally, the terminal device may search for the DCI in a common search space. Specifically, time at which the terminal device searches for the DCI may be determined depending on whether an update that is of the duration of the first active time period and that is indicated by the first indication information is specifically to extend or shorten the duration of the first active time period. For example, if the first indication information indicates the terminal device to extend the duration of the first active time period, the time at which the terminal device searches for the DCI may be the last slot of the duration of the first active time period or the last PDCCH of the duration of the first active time period by default, or the common search space for searching for the DCI by the terminal device is separately configured. For another example, if the first indication information indicates the terminal device to shorten the duration of the first active time period, the time at which the terminal device searches for the DCI may be a slot or a PDCCH in the middle of the duration of the first active time period by default, or the common search space for searching for the DCI by the terminal device is separately configured. For example, when determining that the duration of the first active time period may be shortened, the first network device sends corresponding DCI to the terminal device, and the terminal device searches for the DCI based on a configured PDCCH.

TABLE 1

| radio network | | transmission | logical |
|---|---|---|---|
| temporary identifier | purpose | channel | channel |
| power saving-radio | network power | none | none |
| network temporary | saving indication | | |
| identifier (PS-RNTI) | | | |

In some embodiments, the first indication information is sent via UE-specific DCI. Specifically, the first network device may send the first indication information to some terminal devices via the UE-specific DCI.

It should be noted that the first indication information indicates to update the duration of the first active time period may mean indicating to extend the duration of the first active time period or shorten the duration of the first active time period. By way of example but not limitation, when the first network device determines that there is a data packet whose transmission is uncompleted at an end of the duration of the first active time period, the first network device may send the first indication information to indicate the terminal device to extend the duration of the first active time period. The first indication information may be sent at an end of the first active time period, or may be sent before an end of the first active time period. By way of example but not limitation, when the first network device determines that the terminal device has no data packet to be transmitted, the first network device may send the first indication information to indicate the terminal device to shorten the duration of the first active time period, in other words, to end the active time period in advance. The first indication information may be sent in a time period before the end of the first active time period.

It should be noted that the first network device sends the first indication information to indicate to update the duration of the first active time period. Optionally, the indicating to update the duration of the first active time period may specifically be indicating to extend duration or shorten the duration. Optionally, extended duration or shortened duration of the active time period may start from a sending moment or a receiving moment of the first indication information. Optionally, the extended duration of the active time period may start from an end of the active time period, in other words, start from the last slot/symbol or the like of the active time period.

Specifically, when the extended duration or the shortened duration of the active time period starts from the sending moment or the receiving moment of the first indication information, a specific example is provided in embodiments of the disclosure to facilitate understanding by a reader. For example, when there still are three slots before the end of the active time period, the terminal device receives the first indication information, and the extended duration of the active time period is eight slots. In this case, the third-to-last slot of the active time period is a start slot of the extended duration of the active time period, and the extended duration of the active time period ends after the eight slots. In other words, in this example, an end slot of updated duration of the first active time period is the 5th slot after the last slot of the active time period.

Specifically, when an extended duration of the active time period starts from the end of the duration of the first active time period, namely, the last slot of the duration of the first active time period, corresponding to the foregoing example, the last slot of the duration of the first active time period is a start slot of the extended duration of the active time period, and the extended duration of the active time period ends after eight slots, in other words, an end slot of updated duration of the first active time period is the 8th slot after the last slot of the active time period.

Optionally, when there is a mechanism for updating the duration of the first active time period in a communication system, the first indication information sent by the first network device may not be used for indicating to update the duration of the first active time period. The terminal device may determine, based on an update condition of the duration of the first active time period, whether to update the duration of the first active time period.

Optionally, the update condition of the duration of the first active time period may be included in the first power saving information and sent to the terminal device. Optionally, the update condition of the duration of the first active time period may be set by default by the terminal device or predefined in the protocol.

Specifically, when the update condition of the duration of the first active time period is met, the terminal device determines the updated duration of the first active time period.

It should be noted that the updated duration of the first active time period may be predefined in the protocol, the updated duration of the first active time period may be indicated in the first power saving information, the updated duration of the first active time period may be determined by the terminal device based on a situation of the terminal device, or the updated duration of the first active time period may be configured by the first network device via separate signaling.

Specifically, the update condition of the duration of the first active time period may include an extending condition of the duration of the first active time period. The extending condition of the duration of the first active time period may include at least one of the following:
in last N slots or non-slots of the first active time period, the terminal device detects scheduling information for the terminal device, for example, downlink scheduling information or uplink scheduling information, where N is a positive integer, and N may be a preset value, or N may be a value configured by the first network device for the terminal device; and it should be noted that the first network device may broadcast the value of N in a system information;
a data volume scheduled by the terminal device in the first active time period is less than a threshold, where in a specific example, before the end of the first active time period, a data volume scheduled in an UL grant is less than a BSR value reported by the terminal device; and
in the first active time period, the terminal device has at least one transport block that is not successfully transmitted, where specifically, the transport block may include one or more data packets.

Specifically, the update condition of the duration of the first active time period may alternatively include a shortening condition of the duration of the first active time period. The shortening condition of the duration of the first active time period may also include aspects corresponding to the foregoing aspects:
in M consecutive slots or non-slots in the duration of the first active time period, the terminal device detects no scheduling information for the terminal device, for example, downlink scheduling information or uplink scheduling information, where M is a positive integer, and M may be a preset value, or M may be a value configured by the first network device for the terminal device; and it should be noted that the first network device may broadcast the value of M in a system information; and
in M slots or non-slots before the end of the duration of the first active time period, a data volume scheduled by the terminal device has reached a threshold, where M is a positive integer, and M is a preset value, or M is a value configured by the first network device for the terminal device.

It should be noted that the non-slot may also be referred to as a mini-slot.

It should be understood that the update condition of the duration of the first active time period is a condition for the terminal device to determine, based on an actual situation, whether the active time period needs to be extended or the active time period needs to end in advance. Specific content of the update condition of the duration of the first active time period is not specifically limited in embodiments of the disclosure, and only several examples are provided for ease of understanding by a reader.

Optionally, in some embodiments, a mechanism for updating the duration of the first active time period is not configured in the communication system.

In some embodiments, in the communication system in which the mechanism for updating the duration of the first active time period is not configured, when the duration of the first active time period ends, the first network device enters the dormant time period. If the terminal device has data that is not correctly decoded, the terminal device takes a corresponding measure to match a state of the first network device.

Optionally, for the downlink information sent by the first network device to the terminal device, when the terminal device has downlink data that is not correctly received, and correspondingly, a time point at which the terminal device is to send an uplink hybrid automatic repeat request (HARQ) feedback to the first network device is in duration of the dormant time period of the first network device, the terminal device clears data that is in a HARQ process.

Optionally, for the downlink information sent by the first network device to the terminal device, when the terminal device has downlink data that is not correctly received, and correspondingly, the terminal device has sent an uplink HARQ feedback to the first network device, but has not received retransmitted data of the first network device, the terminal device clears data that is in a HARQ process.

Optionally, for the downlink information sent by the first network device to the terminal device, when the terminal device has downlink data that is not correctly received, and correspondingly, a time point at which the terminal device is to send an uplink HARQ feedback to the first network device is in duration of the dormant time period of the first network device, optionally, the terminal device clears or retains, based on a condition predefined in a protocol, data that is in a HARQ process. For example, the condition predefined in the protocol may be that when a minimum delay in a QoS requirement corresponding to the data that is in the HARQ process is less than the duration of the dormant time period, the data in the HARQ process is cleared.

Optionally, for the downlink information sent by the first network device to the terminal device, when the terminal device has downlink data that is not correctly received, and correspondingly, the terminal device has sent an uplink HARQ feedback to the first network device, but has not received retransmitted data of the first network device, optionally, the terminal device clears or retains, based on a condition predefined in a protocol, data that is in a HARQ process. For example, the condition predefined in the protocol may be that when a minimum delay in a QoS requirement corresponding to the data that is in the HARQ process is less than duration of the dormant time period, the data in the HARQ process is cleared.

Optionally, for the uplink information sent by the terminal device to the first network device, when the terminal device has sent uplink data to the first network device, and the terminal device has not received a HARQ feedback from the first network device when the first network device enters duration of the dormant time period, optionally, the terminal device retains data that is in a HARQ process, waits until the first network device enters a first active time period of a next first power saving cycle, receives an indication of the first network device, and then determines whether to clear the data that is in the HARQ process; optionally, the terminal device clears data that is in a HARQ process; optionally, the terminal device clears or retains, based on a condition predefined in a protocol, data that is in a HARQ process. For example, the condition predefined in the protocol may be that when a minimum delay in a QoS requirement corresponding to the data that is in the HARQ process is less than the duration of the dormant time period, the data in the HARQ process is cleared.

Optionally, the first network device may receive second power saving information of a second network device, where the second power saving information is related information of the second network device in a power saving state. It should be understood that the second network device may be one or more network devices, and the second network device may correspond to one or more cells. Optionally, the one or more cells corresponding to the second network device may be neighboring cells of one or more cells corresponding to the first network device.

In some cases, the second network device may be equivalent to the one or more cells corresponding to the second network device.

It should be noted that the first network device may receive the second power saving information of the second network device through an interface between network devices, for example, an Xn interface, an X2 interface, or an interface between other radio access network devices. This is not limited in embodiments of the disclosure.

In some embodiments, the first network device and the second network device are base stations, and the second power saving information may be included in an inter-base station interface establishment message, or may be included in an inter-base station configuration update message (NG-RAN Node Configuration update). This is not limited in embodiments of the disclosure.

FIG. 5 is a schematic flowchart in which the first network device receives the second power saving information of the second network device. Specifically, the second power saving information includes at least one of the following: duration of a second power saving cycle, duration of a second active time period, and a second time domain offset. Specific meanings of the duration of the second power saving cycle, the duration of the second active time period, and the second time domain offset are basically the same as specific meanings of the duration of the first power saving cycle, the duration of the first active time period, and the first time domain offset, and only the first network device needs to be replaced with the second network device.

Optionally, the first network device sends configuration information to the terminal device.

Specifically, the configuration information indicates the terminal device to measure a neighboring cell, where the neighboring cell corresponds to the second network device. Optionally, the configuration information indicates the terminal device to perform intra-frequency and/or inter-frequency measurement on the neighboring cell.

Specifically, the configuration information includes the second power saving information.

For example, when a terminal device in an idle state or a third state performs intra-frequency or inter-frequency measurement, the first network device sends the configuration information to the terminal device. Optionally, the configuration information is sent to the terminal device in a SIBI in a broadcast form. Intra-frequency or inter-frequency carrier information in the configuration information indicates a list of neighboring cells that need to be measured by the terminal device. The first network device includes, in the list of neighboring cells of the configuration information, second power saving information corresponding to each neighboring cell. Because the second power saving information, corresponding to each neighboring cell, of the second network device in the power saving state may be different, the first network device carries, in the list of neighboring cells of the configuration information, the second power saving information corresponding to the neighboring cell, so that the terminal device is prevented from performing unnecessary measurement when the neighboring cell is in a dormant state. This reduces power consumption of the terminal device.

For example, when the terminal device in a connected state performs measurement, the first network device sends the configuration information to the terminal device. The configuration information includes a measured object. Optionally, the measured object includes a measured cell. Optionally, for each measured cell, the configuration may carry second power saving information, of the second network device, corresponding to the cell.

S320: The terminal device obtains the first power saving information sent by the first network device.

This step cooperates with a related step in step S310, to be specific, the terminal device communicates with the first network device based on the first power saving information. For a detailed description, refer to step S310. Details are not described herein again in embodiments of the disclosure again.

It should be noted that the terminal device may be a terminal device configured with a discontinuous reception (DRX) mechanism.

It should be noted that when the terminal device is a terminal device configured with DRX, when the first network device enters the duration of the dormant time period, if the terminal device is still in a DRX active time period, the terminal device ends the DRX active time period and enters the dormant time period. Specifically, the terminal device may stop a timer related to the DRX. The timer includes but is not limited to:
a DRX inactivity timer, an on duration timer, a uplink/downlink retransmission timer (UL/DL retransmission timer), and a HARQ round trip time timer (HARQ RTT timer).

Alternatively, when the terminal device is in a DRX dormant time period, and the first network device is in the active time period, the terminal device still keeps in the dormant time period.

Optionally, when the first network device is in the dormant time period, the terminal device may not send the uplink information to the first network device by default.

Optionally, when the first network device is in the dormant time period, the terminal device may determine, based on second indication information sent by the first network device, whether to send the uplink information to the first network device. The second indication information indicates whether the first network device receives the uplink information in the dormant time period. If the second indication information indicates the first network device to receive the uplink information in the dormant time period, the terminal device may send the uplink information to the first network device in the dormant time period based on an indication of the second indication information.

It should be noted that the dormant time period of the first network device may be remaining duration other than the duration of the first active time period of the first power saving cycle, or the dormant time period of the first network device may be remaining duration other than the updated duration of the first active time period of the first power saving cycle.

Optionally, corresponding to step S310, when power saving information is exchanged between network devices, the terminal device receives the configuration information sent by the first network device. Specifically, after receiving a system information including the intra-frequency or inter-frequency measurement, the terminal device determines a measurement moment based on a measurement signal, measurement time, and the power saving information corresponding to the neighboring cell that are configured based on the configuration information.

S330: The first network device communicates with the terminal device based on the first power saving information.

It should be noted that, that the first network device communicates with the terminal device based on the first power saving information is specifically described in the foregoing steps S310 and S320. Details are not described in this step.

According to the method provided in embodiments of the disclosure, when determining that the first network device can enter the power saving state, the first network device sends first power saving information to the terminal device, where the first power saving information includes the duration of the first power saving cycle, and the duration of the first active time period in the duration of the first power saving cycle. The first network device communicates with the terminal device in some duration (namely, the duration of the first active time period) of the duration of the first power saving cycle, and keeps in a dormant state in some duration (namely, the duration of the first dormant time period), so that the first network device can implement shutdown at a smaller granularity in time domain. This helps reduce power consumption of the first network device. In addition, the terminal device obtains shutdown information of the first network device in time domain by obtaining the first power saving information, to avoid invalid data receiving and sending. This helps reduce power consumption of the terminal device. In addition, the terminal device may determine, based on the indication of the first network device or based on the update condition of the duration of the first active time period, whether to update the duration of the first active time period, so that more flexible communication shutdown is implemented. In addition, the power saving information is exchanged between the network devices. When the first network device configures measurement information, including the power saving information corresponding to the neighboring cell, of the neighboring cell for the terminal device, the terminal device is enabled to determine the measurement moment based on the power saving information. This avoids resource waste caused by unnecessary measurement.

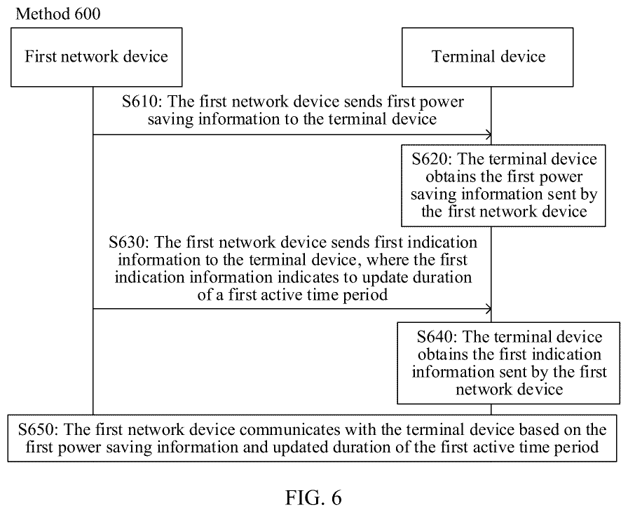

FIG. 6 shows another example of a communication method according to an embodiment of the disclosure. In the method shown in FIG. 6, a first network device indicates, via first indication information, a terminal device to update duration of a first active time period. The method 600 includes the following steps.

S610: The first network device sends first power saving information to the terminal device.

Specifically, the first power saving information is information related to power saving of the first network device. Alternatively, the first power saving information is related information that is after the first network device enters a power saving state.

Specifically, before sending the first power saving information to the terminal device, the first network device needs to determine whether the first network device can enter the power saving state. A description about whether the first network device can enter the power saving state is similar to that in step S310. For details, refer to the related description in step S310. Details are not described in embodiments of the disclosure again.

Specifically, the first power saving information includes at least one of the following: a first power saving cycle, the duration of the first active time period, and a first time domain offset. For a specific description of the first power saving information, refer to step S310. Details are not described in embodiments of the disclosure again.

S620: The terminal device obtains the first power saving information sent by the first network device.

Correspondingly, the terminal device obtains the first power saving information sent by the first network device, and the terminal device communicates with the first network device based on the first power saving information.

S630: The first network device sends the first indication information to the terminal device, where the first indication information indicates to update the duration of the first active time period.

For a description of the first indication information, refer to step S310. Details are not described in embodiments of the disclosure again.

It should be noted that the first indication information may be sent to a group of terminal devices via group common DCI, and the first indication information is sent in a multicast manner, so that a plurality of terminal devices may be simultaneously indicated to update the duration of the first active time period. This reduces transmission resources.

S640: The terminal device obtains the first indication information sent by the first network device.

Correspondingly, the terminal device obtains the first indication information, updates the duration of the first active time period based on the first indication information, and communicates with the first network device based on the first power saving information and the updated duration of the first active time period.

S650: The first network device communicates with the terminal device based on the first power saving information and the updated duration of the first active time period.

The first network device and the terminal device determine the updated duration of the first active time period based on the first power saving information and the first indication information, and perform communication based on the updated duration of the first active time period. A description of determining the updated duration of the first active time period based on the first indication information is similar to the description of step S310. Details are not described in embodiments of the disclosure again.

It should be noted that in embodiments of the disclosure, the first network device may interact with the second network device to obtain the second power saving information of the second network device. When the terminal device is to measure a cell corresponding to the second network device, the first network device may include the obtained second power saving information in configuration information and send the configuration information to the terminal device, so that the terminal device measures, at a corresponding time point based on the second power saving information that is in the configuration information, the cell corresponding to the second network device. For details, refer to related descriptions of step S310 in the method 300.

It should be noted that, in embodiments of the disclosure, if the terminal device is a terminal device configured with DRX, when the DRX active time period of the terminal device configured with the DRX conflicts with the active time period of the first power saving information of the first network device, a description about whether the terminal device keeps dormant or active is similar to the description of step S320 in the method 300. For details, refer to step S320. Details are not described herein again.

According to the method provided in embodiments of the disclosure, after entering the power saving state, the first network device sends the first power saving information to the terminal device, so that the first network device can communicate with the terminal device based on the first power saving information, and data is not transmitted at some time periods. This reduces system power consumption. When the first network device determines, based on an actual communication requirement, to update the duration of the first active time period, the first network device sends the first indication information to the terminal device in a multicast manner, to indicate the terminal device to update the duration of the first active time period, to flexibly control the duration of the first active time period. This reduces system power consumption more flexibly.

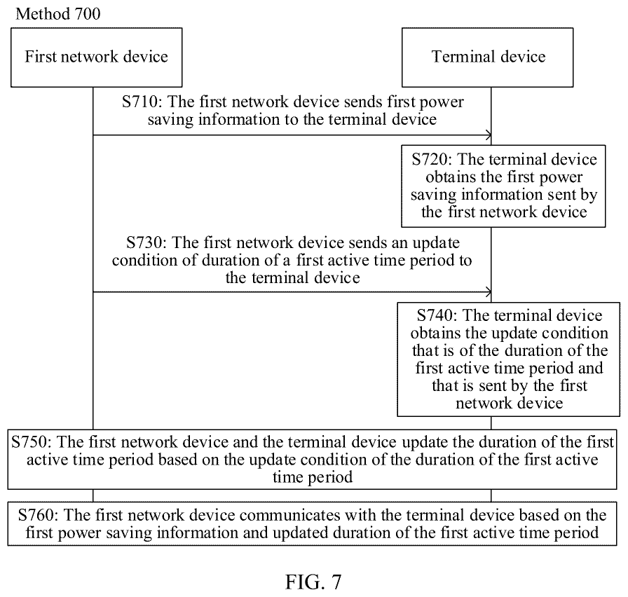

FIG. 7 shows another example of a communication method according to an embodiment of the disclosure. In the method shown in FIG. 7, a terminal device determines, based on an update condition of duration of a first active time period, to update the duration of the first active time period. The method 700 includes the following steps.

S710: A first network device sends first power saving information to the terminal device.

Specifically, the first power saving information is information related to power saving of the first network device. Alternatively, the first power saving information is related information that is after the first network device enters a power saving state.

Specifically, before sending the first power saving information to the terminal device, the first network device needs to determine whether the first network device can enter the power saving state. A description about whether the first network device can enter the power saving state is similar to that in step S310. For details, refer to the related description in step S310. Details are not described in embodiments of the disclosure again.

S720: The terminal device obtains the first power saving information sent by the first network device.

Correspondingly, the terminal device obtains the first power saving information sent by the first network device, and the terminal device communicates with the first network device based on the first power saving information.

S730: The first network device sends an update condition of the duration of the first active time period to the terminal device.

Optionally, the update condition of the duration of the first active time period may be included in the first power saving information and sent to the terminal device.

Optionally, the update condition of the duration of the first active time period may be set by the terminal device by default, and does not need to be sent by the first network device to the terminal device.

It should be noted that, for related descriptions of the update condition of the duration of the first active time period, refer to step S310. Details are not described in embodiments of the disclosure again.

It should be noted that step S730 is optional. A sequence between step S730 and step S710 is adjustable.

S740: The terminal device obtains the update condition that is of the duration of the first active time period and that is sent by the first network device.

It should be noted that step S740 is optional. A sequence between step S740 and step S720 is adjustable.

S750: The terminal device and the first network device update the duration of the first active time period based on the update condition of the duration of the first active time period.

Specifically, the terminal device determines, based on the update condition of the duration of the first active time period, whether to update the duration of the first active time period. Specifically, the update condition of the duration of the first active time period is described in step S310. Details are not described in embodiments of the disclosure again.

S760: The first network device communicates with the terminal device based on the first power saving information and updated duration of the first active time period.

It should be noted that in embodiments of the disclosure, the first network device may interact with a second network device to obtain second power saving information of the second network device. When the terminal device is to measure a cell corresponding to the second network device, the first network device may include the obtained second power saving information in configuration information and send the configuration information to the terminal device, so that the terminal device measures, at a corresponding time point based on the second power saving information that is in the configuration information, the cell corresponding to the second network device. For details, refer to related descriptions of step S310 in the method 300.

It should be noted that, in embodiments of the disclosure, if the terminal device is a terminal device configured with DRX, when the DRX active time period of the terminal device configured with the DRX conflicts with the active time period of the first power saving information of the first network device, a description about whether the terminal device keeps dormant or active is similar to the description of step S320 in the method 300. For details, refer to step S320. Details are not described herein again.

In comparison with the method 600, in the method provided in embodiments of the disclosure, the terminal device determines, based on the update condition of the duration of the first active time period, whether to update the duration of the first active time period, and the first network device does not need to send first indication information for indication, so that the terminal device can perform determining based on a requirement. This avoids asymmetric actions on two sides caused when the first network device side cannot perform indication. This solution is more flexible.

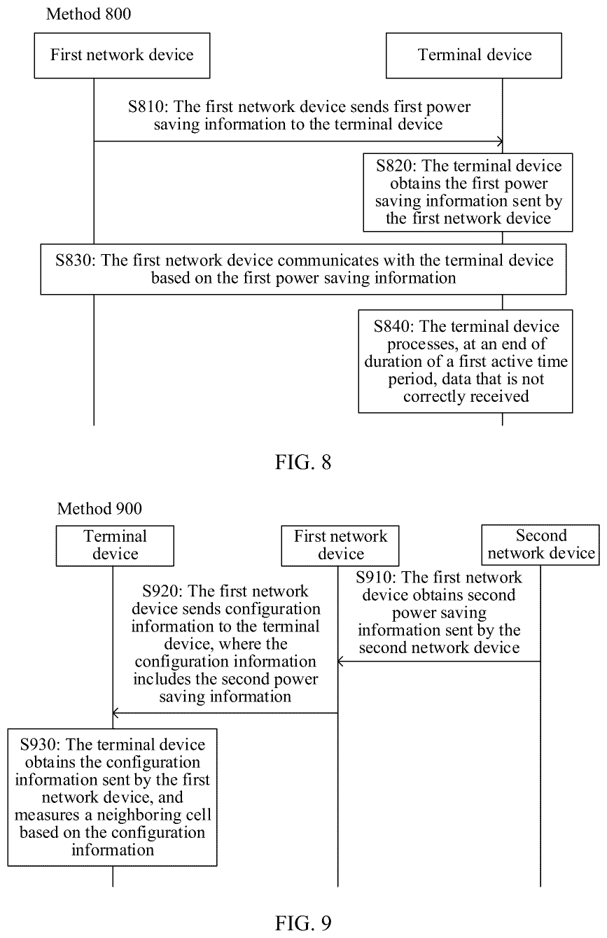

FIG. 8 is another example of a communication method according to an embodiment of the disclosure. In the method shown in FIG. 8, there is no update mechanism for duration of a first active time period, and a terminal device determines, based on a data receiving status at an end of the duration of the first active time period, whether to clear data that is not correctly received. The method 800 includes the following steps.

S810: A first network device sends first power saving information to the terminal device.

Specifically, the first power saving information is information related to power saving of the first network device. Alternatively, the first power saving information is related information that is after the first network device enters a power saving state.

Specifically, before sending the first power saving information to the terminal device,

the first network device needs to determine whether the first network device can enter the power saving state. A description about whether the first network device can enter the power saving state is similar to that in step S310. For details, refer to the related description in step S310. Details are not described in embodiments of the disclosure again.

S820: The terminal device obtains the first power saving information sent by the first network device.

Correspondingly, the terminal device obtains the first power saving information sent by the first network device, and the terminal device communicates with the first network device based on the first power saving information.

S830: The first network device communicates with the terminal device based on the first power saving information.

Specifically, the first network device communicates with the terminal device in the duration of the first active time period.

S840: The terminal device processes, at the end of the duration of the first active time period, the data that is not correctly received.

When there is no update mechanism of the duration of the first active time period, if the terminal device has, at the end of the duration of the first active time period, the data that is not correctly transmitted, for an action performed by the terminal device, refer to the description of step S310 in the method 300.

It should be noted that in embodiments of the disclosure, the first network device may interact with a second network device to obtain the second power saving information of the second network device. When the terminal device is to measure a cell corresponding to the second network device, the first network device may include the obtained second power saving information in configuration information and send the configuration information to the terminal device, so that the terminal device measures, at a corresponding time point based on the second power saving information that is in the configuration information, the cell corresponding to the second network device. For details, refer to related descriptions of step S310 in the method 300.

It should be noted that, in embodiments of the disclosure, if the terminal device is a terminal device with DRX, when the DRX active time period of the terminal device with the DRX conflicts with the active time period of the first power saving information of the first network device, a description about whether the terminal device keeps dormant or active is similar to the description of step S320 in the method 300. For details, refer to step S320. Details are not described herein again.

In the method provided in embodiments of the disclosure, there is no update mechanism of the duration of the first active time period. At the end of the duration of the first active time period, a method for processing the data that is not correctly transmitted is provided, so that a related mechanism for the first network device to enter the power saving state is more complete. This reduces system power consumption.

FIG. 9 is another example of a communication method according to an embodiment of the disclosure. In the method shown in FIG. 9, a first network device and a second network device exchange power saving information, so that a terminal device can measure a neighboring cell at an appropriate moment. The method 900 includes the following steps.

S910: The first network device obtains second power saving information sent by the second network device.

Specifically, the second power saving information is related information of the second network device in a power saving state. It should be understood that the second network device may be one or more network devices, and the second network device may correspond to one or more cells. Optionally, the one or more cells corresponding to the second network device may be neighboring cells of one or more cells corresponding to the first network device.

The second power saving information includes at least one of the following: a second power saving cycle, duration of a second active time period, and a second time domain offset. Specific meanings of the second power saving cycle, the duration of the second active time period, and the second time domain offset are basically the same as specific meanings of a first power saving cycle, duration of a first active time period, and a first time domain offset. For details, refer to the description of S310 in the method 300, and only the first network device needs to be replaced with the second network device.

In some cases, the second network device may be equivalent to the one or more cells corresponding to the second network device.

It should be noted that the first network device may receive the second power saving information of the second network device through an interface between network devices, for example, an Xn interface, an X2 interface, or an interface between other radio access network devices. This is not limited in embodiments of the disclosure.

In some embodiments, the first network device and the second network device are base stations, and the second power saving information may be included in an inter-base station interface establishment message, or may be included in an inter-base station configuration update message. This is not limited in embodiments of the disclosure.

S920: The first network device sends configuration information to the terminal device, where the configuration information includes the second power saving information.

Specifically, the first network device sends the configuration information to the terminal device, where the configuration information is used by the terminal device to measure the neighboring cell, and the first network device may include, in the configuration information, the second power saving information corresponding to the neighboring cell. For details, refer to the description of step S310 in the method 300.

S930: The terminal device receives the configuration information sent by the first network device, and further, the terminal device measures the neighboring cell based on the configuration information.

The terminal device receives the configuration information sent by the first network device, and selects, based on the second power saving information corresponding to the neighboring cell, a corresponding time point to measure the neighboring cell. For an example in which the configuration information is separately set in an idle state and a connected state, refer to step S310 in the method 300. Details are not described herein again in the disclosure.

According to the method provided in embodiments of the disclosure, the exchange of the power saving information is performed between the network devices, and the configuration information includes related power saving information corresponding to a to-be-measured cell, so that the terminal device measures the to-be-measured cell when the to-be-measured cell is in an active time period. This prevents the terminal device from performing unnecessary measurement, and reduces power consumption of the terminal device.

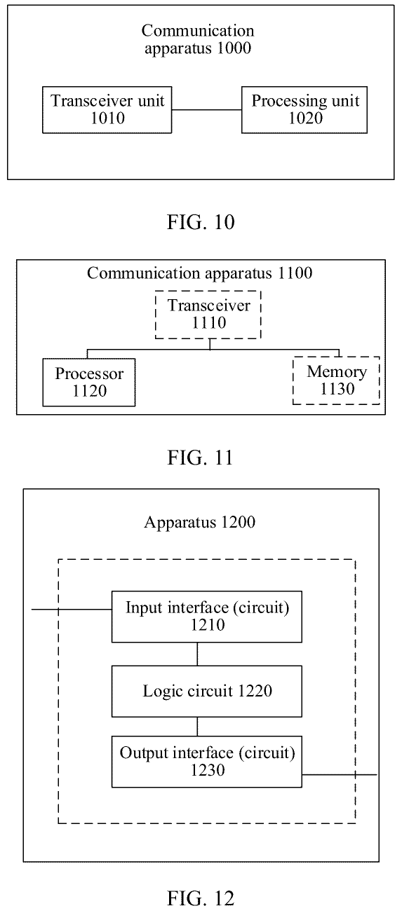

FIG. 10 is an example of a communication apparatus according to an embodiment of the disclosure. As shown in FIG. 10, the communication apparatus 1000 includes a transceiver unit 1010 and a processing unit 1020. In some embodiments, the communication apparatus 1000 may be configured to implement a function of the terminal device in any one of the foregoing methods. For example, the communication apparatus 1000 may correspond to a terminal device.

The communication apparatus 1000 may be the terminal device, and performs the steps performed by the terminal device in the foregoing method embodiments. The transceiver unit 1010 may be configured to support the communication apparatus 1000 in performing communication, for example, performing sending and/or receiving actions performed by the terminal device in the foregoing method embodiments. The processing unit 1020 may be configured to support the communication apparatus 1000 in performing processing actions in the foregoing method embodiments, for example, performing processing actions performed by the terminal device in the foregoing method embodiments.

Optionally, the communication apparatus may further include a storage unit 1030 (which is not shown in FIG. 10), configured to store program code and data of the communication apparatus.

Specifically, reference may be made to the following description.

The processing unit 1020 is configured to determine first power saving information sent by a first network device, where the first power saving information is information related to power saving of the first network device.

The transceiver unit 1010 is configured to obtain the first power saving information sent by the first network device.

The transceiver unit 1010 is further configured to communicate with the first network device based on the first power saving information.

The first power saving information includes at least one of the following:
duration of a first power saving cycle;
duration of a first active time period, where the duration of the first active time period is duration in which the first network device communicates with the processing unit in the duration of the first power saving cycle, and the duration of the first active time period is less than the duration of the first power saving cycle; and
a first time domain offset, where the first time domain offset is a start time point of the first power saving cycle.

That the transceiver unit 1010 communicates with the first network device based on the first power saving information includes:

The transceiver unit 1010 communicates with the first network device in the duration of the first active time period.

Optionally, the first power saving information further includes an update condition of the duration of the first active time period.

Specifically, the update condition of the duration of the first active time period includes at least one of the following:
the transceiver unit 1010 receives scheduling information in N slots before an end of the duration of the first active time period, where N is a positive integer;
a data volume scheduled by the processing unit 1020 before the end of the duration of the first active time period is less than a threshold; or
the transceiver unit 1010 has a transport block that is unsuccessfully transmitted before the end of the duration of the first active time period.

When the update condition of the duration of the first active time period is met, the processing unit 1020 is configured to determine updated duration of the first active time period.

Optionally, the transceiver unit 1010 is further configured to receive first indication information sent by the first network device in a multicast manner, where the first indication information is scrambled by using a predefined radio network temporary identifier RNTI, and the predefined RNTI indicates to update the duration of the first active time period.

The processing unit 1020 is configured to determine the updated duration of the first active time period based on the first indication information.

Optionally, the transceiver unit 1010 is configured to receive configuration information sent by the first network device, where the configuration information includes second power saving information, and the second power saving information is information related to power saving of a second network device.

The processing unit 1020 measures, based on the configuration information, a cell corresponding to the second network device.

Optionally, the transceiver unit 1010 is further configured to receive second indication information of the first network device, where the second indication information indicates whether the first network device receives uplink information in duration of a first dormant time period, and the duration of the first dormant time period is obtained based on the duration of the first power saving cycle and the duration of the first active time period, or the duration of the first dormant time period is obtained based on the duration of the first power saving cycle and the updated duration of the first active time period.

When the second indication information indicates the first network device to receive the uplink information in the duration of the first dormant time period, the transceiver unit 1010 sends the uplink information to the first network device in the duration of the first dormant time period.

In some embodiments, the communication apparatus 1000 may be configured to implement a function of the first network device in the foregoing method. For example, the communication apparatus 1000 may correspond to the first network device.

The communication apparatus 1000 may be the first network device, and performs the steps performed by the first network device in the foregoing method embodiments. The transceiver unit 1010 may be configured to support the communication apparatus 1000 in performing communication, for example, performing sending and/or receiving actions performed by the first network device in the foregoing method embodiments. The processing unit 1020 may be configured to support the communication apparatus 1000 in performing processing actions in the foregoing method embodiments, for example, performing processing actions performed by the first network device in the foregoing method embodiments.

Optionally, the communication apparatus may further include a storage unit 1030 (which is not shown in FIG. 10), configured to store program code and data of the communication apparatus.

Specifically, reference may be made to the following description.

The processing unit 1020 is configured to determine the first power saving information, where the first power saving information is information related to power saving of the first network device.

The transceiver unit 1010 is configured to send the first control information to the terminal device.

The transceiver unit 1010 is further configured to communicate with the terminal device based on the first power saving information.

The first power saving information includes at least one of the following:
the duration of the first power saving cycle;
the duration of the first active time period, where the duration of the first active time period is duration in which the first network device communicates with the processing unit in the duration of the first power saving cycle, and the duration of the first active time period is less than the duration of the first power saving cycle; and
the first time domain offset, where the first time domain offset is a start time point of the first power saving cycle.

That the transceiver unit 1010 communicates with the terminal device based on the first

power saving information includes:

The transceiver unit 1010 communicates with the terminal device in the duration of the first active time period.

Optionally, the first power saving information further includes an update condition of the duration of the first active time period.

Specifically, the update condition of the duration of the first active time period includes at least one of the following:
the terminal device receives scheduling information in N slots before an end of the duration of the first active time period, where N is a positive integer;
a data volume scheduled by the terminal device before the end of the duration of the first active time period is less than a threshold; and
the terminal device has a transport block that is unsuccessfully transmitted before the end of the duration of the first active time period.

When the update condition of the duration of the first active time period is met, the processing unit 1020 is configured to determine updated duration of the first active time period.

Optionally, the transceiver unit 1010 is further configured to send the first indication information to the terminal device in a multicast manner, where the first indication information is scrambled by using a predefined radio network temporary identifier RNTI, and the predefined RNTI indicates to update the duration of the first active time period.

The processing unit 1020 is configured to determine the updated duration of the first active time period.

Optionally, the transceiver unit 1010 is configured to receive second power saving information sent by the second network device, where the second power saving information is information related to power saving of the second network device.

The transceiver unit 1010 is further configured to send configuration information to the terminal device, where the configuration information includes the second power saving information, and the configuration information is used by the terminal device to measure a cell corresponding to the second network device.

The transceiver unit 1010 is further configured to send second indication information to the terminal device, where the second indication information indicates whether the transceiver unit 1010 receives the uplink information in the duration of the first dormant time period, and the duration of the first dormant time period is determined based on the first power saving cycle and the duration of the first active time period, or the duration of the first dormant time period is determined based on the first power saving cycle and the updated duration of the first active time period.

FIG. 11 is an example of a signal transmission apparatus 1100 according to an embodiment of the disclosure. As shown in FIG. 11, the apparatus 1100 includes a transceiver 1110, a processor 1120, and a memory 1130. The memory 1130 is configured to store instructions. The processor 1120 is coupled to the memory 1130, and is configured to execute instructions stored in the memory, to perform the method provided in embodiments of the disclosure.

Specifically, the transceiver 1110 in the apparatus 1100 may correspond to the transceiver unit 1010 in the apparatus 1000, and the processor 1120 in the apparatus 1100 may correspond to the processing unit 1020 in the communication apparatus 1000.

It should be understood that the memory 1130 and the processor 1120 may be combined into one processing apparatus, and the processor 1120 is configured to execute the program code stored in the memory 1130 to implement the foregoing functions. In specific implementation, the memory 1130 may alternatively be integrated into the processor 1120, or may be independent of the processor 1120.

FIG. 12 is a schematic diagram of another example of a communication apparatus according to an embodiment of the disclosure. The communication apparatus may be configured to perform the method performed by the first network device or the terminal device. As shown in FIG. 12, the communication apparatus includes:
at least one input interface (Input(s)) 1210, a logic circuit 1220, and at least one output interface (Output(s)) 1230. Optionally, the foregoing logic circuit may be a chip, or another integrated circuit that may implement the method in the disclosure.

The input interface 1210 is configured to input or receive data. The output interface 1230 is configured to output or send data. The logic circuit 1220 is configured to perform the foregoing possible methods shown in FIG. 3 to FIG. 9.

A person of ordinary skill in the art may be aware that, in combination with the examples described in embodiments disclosed in this specification, units and algorithm steps may be implemented by electronic hardware or a combination of computer software and electronic hardware. Whether these functions are performed in a hardware or software manner depends on a specific disclosure and a design constraint condition of the technical solutions. A person skilled in the art may use different methods to implement the described functions for each specific disclosure, but it should not be considered that the implementation goes beyond the scope of the disclosure.

It may be clearly understood by a person skilled in the art that, for convenient and brief description, for a detailed working process of the foregoing system, apparatus, and units, refer to a corresponding process in the foregoing method embodiments, and details are not described herein again.

In embodiments of the disclosure, it should be understood that the disclosed system, apparatus, and method may be implemented in another manner. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in an electronic form, a mechanical form, or another form.

The units described as separate parts may or may not be physically separate, and parts displayed as units may or may not be physical units, and may be located at one location, or may be distributed on a plurality of network units. Some or all of the units may be selected based on actual requirements to achieve the objectives of the solutions of embodiments.

In addition, functional units in embodiments of the disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the disclosure essentially, or the part contributing to the conventional technology, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of the disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the disclosure shall be subject to the protection scope of the claims.

What is claimed is:

1. A communication method implemented by a first apparatus at a terminal side, comprising:
obtaining first power saving information from a second apparatus at a network side, wherein the first power saving information is related to power saving of a first network device, the first power saving information indicates duration of a first active time period, and the duration of the first active time period is variable; and
communicating with the second apparatus in the duration of the first active time period.

2. The method according to claim 1, wherein the first power saving information further indicates at least one of:
duration of a first power saving cycle, wherein the duration of the first active time period is less than the duration of the first power saving cycle, and
a first time domain offset, wherein the first time domain offset is a start time point of the first power saving cycle.

3. The method according to claim 1, where the duration of the first active time period changes when an update condition of the duration of the first active time period is met.

4. The method according to claim 3, further comprising:
communicating with the second apparatus in a first updated duration of the first active time period when the update condition of the duration of the first active time period is met.

5. The method according to claim 3, wherein the update condition of the duration of the first active time period comprises at least one of:
received scheduling information in last N slots or non-slots of the first active time period, wherein N is a positive integer,
a data volume scheduled by the first apparatus in the first active time period being less than a threshold, or
a transport block that is not successfully received in the first active time period.

6. The method according to claim 1, where the duration of the first active time period changes when receiving first indication information scrambled by using a predefined radio network temporary identifier (RNTI).

7. The method according to claim 6, where the predefined RNTI indicates to update the duration of the first active time period.

8. The method according to claim 6, further comprising:
communicating with the second apparatus in a second updated duration of the first active time period associating with the first indication information.

9. The method according to claim 1, further comprising:
measuring based on configuration information from the second apparatus, a cell corresponding to a third apparatus at the network side, wherein the configuration information comprises second power saving information related to power saving of the third apparatus.

10. The method according to claim 1, further comprising:
obtaining second indication information from the second apparatus, wherein the second indication information indicates whether the first network device receives uplink information in duration of a first dormant time period.

11. The method according to claim 10, where the duration of the first dormant time period is associated with one of:
the duration of the first active time period, or
a updated duration of the first active time period.

12. The method according to claim 1, wherein the second indication information is obtained via a system information.

13. An apparatus at a terminal side, comprising:
a memory configured to store programming instructions and data; and
at least one processor coupled to a memory, wherein the at least one processor is configured to execute the programming instructions in the memory, to cause the apparatus to:
obtain first power saving information from a second apparatus at a network side, wherein the first power saving information is related to power saving of a first network device, the first power saving information indicates duration of a first active time period, and the duration of the first active time period is variable; and
communicate with the second apparatus in the duration of the first active time period.

14. The apparatus according to claim 13, wherein the first power saving information further indicates at least one of:
duration of a first power saving cycle, wherein the duration of the first active time period is less than the duration of the first power saving cycle, and
a first time domain offset, wherein the first time domain offset is a start time point of the first power saving cycle.

15. The apparatus according to claim 13, where the duration of the first active time period changes when an update condition of the duration of the first active time period is met.

16. The apparatus according to claim 15, where the at least one processor is further configured to execute the programming instructions in the memory, to cause the apparatus to:
communicate with the second apparatus in a first updated duration of the first active time period when the update condition of the duration of the first active time period is met.

17. The apparatus according to claim 15, wherein the update condition of the duration of the first active time period comprises at least one of:
received scheduling information in last N slots or non-slots of the first active time period, wherein N is a positive integer,
a data volume scheduled by the apparatus in the first active time period being less than a threshold, or
a transport block that is not successfully received in the first active time period.

18. The apparatus according to claim 13, where the duration of the first active time period changes when receiving first indication information scrambled by using a predefined radio network temporary identifier (RNTI).

19. The apparatus according to claim 18, where the predefined RNTI indicates to update the duration of the first active time period.

20. A non-transitory computer-readable storage medium storing computer instructions, that when executed by one or more processors, cause the one or more processors to:
obtain first power saving information from a second apparatus at a network side, wherein the first power saving information is related to power saving of the first network device and the first power saving information indicates duration of a first active time period and the duration of the first active time period is variable; and
communicate with the second apparatus in the duration of the first active time period.
